(19) United States
(12) Patent Application Publication
(10) Pub. No.: US 2024/0136566 A1
(43) Pub. Date: Apr. 25, 2024

(54) RECHARGEABLE LITHIUM BATTERY

(71) Applicant: SAMSUNG SDI CO., LTD., Yongin-si (KR)

(72) Inventors: Dahyun KIM, Yongin-si (KR); Sanghoon KIM, Yongin-si (KR); Hyunbong CHOI, Yongin-si (KR); Sundae KIM, Yongin-si (KR); Yeji YANG, Yongin-si (KR); Hongryeol PARK, Yongin-si (KR); Sangwoo PARK, Yongin-si (KR)

(21) Appl. No.: 18/457,153

(22) Filed: Aug. 28, 2023

(30) Foreign Application Priority Data
Oct. 11, 2022 (KR) 10-2022-0129919

(51) Int. Cl. H01M 10/0525; H01M 4/1315; H01M 4/134; H01M 4/505; H01M 4/525; H01M 10/0567; H01M 10/0569

(52) U.S. Cl. CPC H01M 10/0525; H01M 4/1315; H01M 4/134; H01M 4/505; H01M 4/525; H01M 10/0567; H01M 10/0569; H01M 2300/0037; H01M 2300/0051

(57) ABSTRACT

A rechargeable lithium battery includes an electrolyte solution including a non-aqueous organic solvent, a lithium salt, and an additive; a positive electrode including a positive electrode active material; and a negative electrode including a negative electrode active material, where the non-aqueous organic solvent includes less than about 5 wt % of ethylene carbonate, based on the total weight of the non-aqueous organic solvent, the additive includes vinylene carbonate (VC), vinylethylene carbonate (VEC), or a mixture thereof, and the positive electrode active material includes a cobalt-free lithium nickel manganese-based oxide.

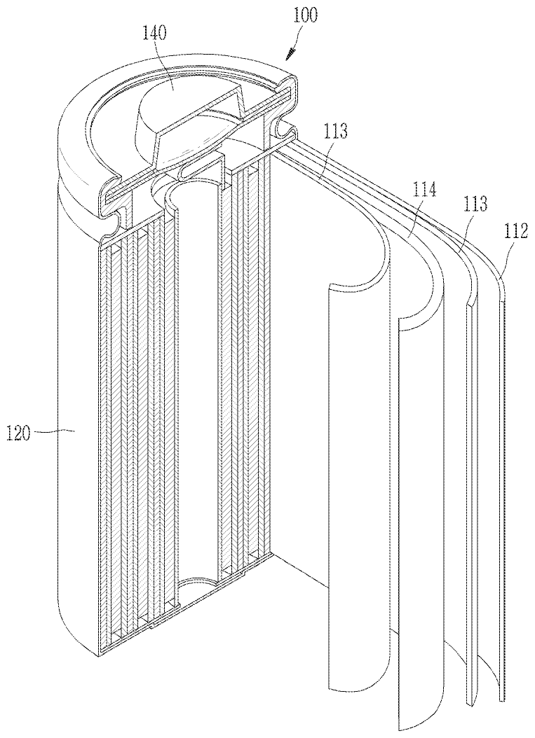

### CROSS-REFERENCE TO RELATED APPLICATION

This application claims priority to and the benefit of Korean Patent Application No. 10-2022-0129919, filed in the Korean Intellectual Property Office on Oct. 11, 2022, the entire content of which is incorporated herein by reference.

### BACKGROUND

### 1. Field

One or more embodiments of the present disclosure relate to a rechargeable lithium battery.

### 2. Description of the Related Art

A rechargeable lithium battery may be recharged after utilization and has three or more times as high energy density per unit weight as a comparable lead storage battery, nickel-cadmium battery, nickel hydrogen battery, nickel zinc battery and/or the like. It may be also charged at a high rate and thus, is commercially manufactured for a laptop, a cell phone, an electric tool, an electric bike, and/or the like, and research on improvement of additional energy density has been actively conducted.

As electronic devices such as information technology devices become increasingly high-performance, high-capacity batteries are desired or required. The high capacity of a battery may be realized by expanding a voltage region to increase energy density, but there is a problem of oxidizing an electrolyte solution in the high-voltage region and thus deteriorating performance of a positive electrode of the battery.

Cobalt-free lithium nickel manganese-based oxide is a positive electrode active material including (no cobalt but) nickel, manganese, and/or the like as a main component in its composition, and a positive electrode including a cobalt-free lithium manganese-based oxide may be economical and realize high energy density; thus, cobalt-free lithium manganese-based oxide has drawn much attention as a next generation positive electrode active material.

However, when the positive electrode including the cobalt-free lithium nickel manganese-based oxide is utilized in a high-voltage environment, transition metals, e.g., nickel, may be eluted due to structural collapse of the positive electrode, thereby generating issues such as gas generation inside a cell, capacity reduction, and/or the like. This transition metal elution tends to be aggravated in a high-temperature environment, where the eluted transition metals may be precipitated on the surface of a negative electrode and may cause a side reaction and thus increase battery resistance and deteriorate battery cycle-life and output characteristics.

Accordingly, when the positive electrode including the cobalt-free lithium nickel manganese-based oxide is utilized, an electrolyte solution applicable under high-voltage and high-temperature conditions is required or desired.

### SUMMARY

One or more aspects of embodiments of the present disclosure are directed toward a rechargeable lithium battery exhibiting improved high-voltage characteristics and high-temperature characteristics by combining a positive electrode including cobalt-free lithium nickel manganese-based oxide with an electrolyte solution capable of effectively protecting the positive electrode including cobalt-free lithium nickel manganese-based oxide to reduce elution of transition metals from the positive electrode under high-voltage and high-temperature conditions and thus to suppress or reduce structural collapse of the positive electrode.

Additional aspects will be set forth in part in the description which follows and, in part, will be apparent from the description, or may be learned by practice of the presented embodiments of the disclosure.

According to one or more embodiments of the present disclosure, a rechargeable lithium battery may include an electrolyte solution including a non-aqueous organic solvent, a lithium salt, and an additive; a positive electrode including a positive electrode active material; and a negative electrode including a negative electrode active material,
wherein the non-aqueous organic solvent may contain less than about 5 wt % of ethylene carbonate, based on the total weight of the non-aqueous organic solvent, and
the additive may include vinylene carbonate (VC), vinylethylene carbonate (VEC), or a mixture thereof, and
the positive electrode active material may include a cobalt-free lithium nickel manganese-based oxide.

The non-aqueous organic solvent may be composed of a chain carbonate alone.

The chain carbonate may be represented by Chemical Formula 1.

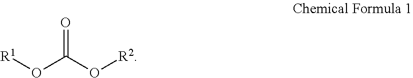

In Chemical Formula 1,

R¹ and R² may each independently be a substituted or unsubstituted C1 to C20 alkyl group.

In one or more embodiments, the non-aqueous organic solvent may be a mixture of two or more solvents selected from dimethyl carbonate (DMC), diethyl carbonate (DEC), dipropyl carbonate (DPC), methylpropyl carbonate (MPC), ethylpropyl carbonate (EPC), and ethylmethyl carbonate (EMC).

In one or more embodiments, the non-aqueous organic solvent may include ethylmethyl carbonate (EMC) and dimethyl carbonate (DMC) in a volume ratio of about 0:100 to about 50:50.

In one or more embodiments, the additive may be included in an amount of about 0.05 to about 5.0 parts by weight based on 100 parts by weight of the electrolyte solution for the rechargeable lithium battery.

In one or more embodiments, the additive may be included in an amount of about 0.05 to about 3.0 parts by weight based on 100 parts by weight of the electrolyte solution for the rechargeable lithium battery.

The electrolyte solution may further include one or more other additives selected from fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, adiponitrile (AN), succinonitrile (SN), 1,3,6-hexane tricyanide (HTCN), propene sultone (PST), propane sultone (PS), lithium tetrafluoroborate (LiBF₄), lithium difluorophosphate (LiPO₂F₂), and 2-fluoro biphenyl (2-FBP).

The cobalt-free lithium nickel manganese-based oxide may include a lithium composite oxide represented by Chemical Formula 3.

LiₐNiₓMn_{y}M¹_{z}M²_{w}O_{2±b}X_{c}. Chemical Formula 3

In Chemical Formula 3,
0.5≤a<1.8, 0≤b≤0.1, 0≤c≤0.1, 0≤w<0.1, 0.6≤x<1.0, 0<y<0.4, 0<z<0.1, w+x+y+z=1,

M¹ and M² may each independently be one or more elements selected from aluminum (Al), magnesium (Mg), titanium (Ti), zirconium (Zr), chromium (Cr), strontium (Sr), vanadium (V), boron (B), tungsten (W), molybdenum (Mo), niobium (Nb), silicon (Si), barium (Ba), calcium (Ca), cerium (Ce), and iron (Fe), and X may be one or more elements selected from sulfur (S), fluorine (F), phosphorus (P), and chlorine (Cl).

In one or more embodiments, the lithium composite oxide represented by Chemical Formula 3 may be represented by Chemical Formula 3-1.

LiₐNiₓ₁Mn_{y1}Al_{z1}M²_{w1}O_{2±b}X_{c}. Chemical Formula 3-1

In Chemical Formula 3-1,
0.5≤a<1.8, 0≤b≤0.1, 0≤c≤0.1, 0≤w1<0.1, 0.6≤x1<1.0, 0<y1<0.4, 0<z1<0.1, w1+x1+y1+z1=1,

M² may each independently be one or more elements selected from Mg, Ti, Zr, Cr, Sr, V, B, W, Mo, Nb, Si, Ba, Ca, Ce, and Fe, and X may be one or more elements selected from S, F, P, and Cl.

In one or more embodiments, in Chemical Formula 3-1, x1 may be 0.6≤x1≤0.79, y1 may be 0.2≤y1≤0.39, and z1 may be 0.01≤z1<0.1.

In one or more embodiments, the negative electrode active material may include graphite, a Si composite, or a mixture thereof.

In one or more embodiments, the rechargeable lithium battery may have a charging upper limit voltage of greater than or equal to about 4.35 V.

Embodiments of the present disclosure may realize a rechargeable lithium battery exhibiting improved battery stability and cycle-life characteristics by combining a positive electrode including cobalt-free lithium nickel manganese-based oxide with an electrolyte solution capable of effectively protecting the positive electrode to secure phase transition safety of the positive electrode in a high-temperature high-voltage environment and to suppress or reduce decomposition of the electrolyte solution and a side reaction with electrodes and thus reduce gas generation while concurrently (e.g., simultaneously), suppress or reduce an increase in battery internal resistance.

### BRIEF DESCRIPTION OF THE DRAWINGS

The accompanying drawing is included to provide a further understanding of the present disclosure, and is incorporated in and constitutes a part of this specification. The drawing illustrates example embodiments of the present disclosure and, together with the description, serve to explain principles of present disclosure. In the drawing:

The drawing is a schematic view illustrating a rechargeable lithium battery according to one or more embodiments of the present disclosure.

### DETAILED DESCRIPTION

The present disclosure may be modified in many alternate forms, and thus specific embodiments will be exemplified in the drawing and described in more detail. It should be understood, however, that it is not intended to limit the present disclosure to the particular forms disclosed, but rather, is intended to cover all modifications, equivalents, and alternatives falling within the spirit and scope of the present disclosure.

Hereinafter, a rechargeable lithium battery according to one or more embodiments of the present disclosure will be described in more detail with reference to the accompanying drawings. However, these embodiments are mere example, the present disclosure is not limited thereto and the present disclosure is defined by the scope of claims and equivalents thereof.

In the present disclosure, unless otherwise defined, “substituted” may refer to replacement of at least one hydrogen in a substituent or compound by deuterium, a halogen, a hydroxyl group, an amino group, a substituted or unsubstituted C1 to C30 amine group, a nitro group, a substituted or unsubstituted C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof.

In one or more embodiments of the present disclosure, “substituted” may refer to replacement of at least one hydrogen in a substituent or compound by deuterium, a halogen, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. In some embodiments, “substituted” may refer to replacement of at least one hydrogen of a substituent or a compound by deuterium, a halogen, a C1 to C20 alkyl group, a C6 to C30 aryl group, a C1 to C10 fluoroalkyl group, or a cyano group. In some embodiments, “substituted” may refer to replacement of at least one hydrogen of a substituent or a compound by deuterium, a halogen, a C1 to C5 alkyl group, a C6 to C18 aryl group, a C1 to C5 fluoroalkyl group, or a cyano group. In some embodiments, “substituted” may refer to replacement of at least one hydrogen of a substituent or a compound by deuterium, a cyano group, a halogen, a methyl group, an ethyl group, a propyl group, a butyl group, a phenyl group, a biphenyl group, a terphenyl group, a trifluoromethyl group, or a naphthyl group.

Rechargeable lithium batteries may be classified as lithium ion batteries, lithium ion polymer batteries, or lithium polymer batteries according to the presence of a separator and the type or kind of electrolyte solution utilized therein. Rechargeable lithium batteries may have a variety of shapes and sizes, for example, may include cylindrical, prismatic, coin, and/or pouch-type or kind batteries, and may be thin film batteries and/or may be rather bulky in size. Structures and manufacturing methods for rechargeable lithium batteries pertaining to the present disclosure are well suitably established in the art.

Herein, a cylindrical rechargeable lithium battery will be exemplarily described as an example of a rechargeable lithium battery. The drawing schematically shows the structure of a rechargeable lithium battery according to one or more embodiments of the present disclosure. Referring to the drawing, a rechargeable lithium battery 100 according to one or more embodiments may include a rechargeable lithium battery cell including a positive electrode 114, a negative electrode 112 facing to the positive electrode 114, and a separator 113 between the positive electrode 114 and the negative electrode 112, and an electrolyte solution impregnating the positive electrode 114, the negative electrode 112, and the separator 113, a battery container 120 housing the rechargeable lithium battery cell, and a sealing member 140 for sealing the battery container 120.

Hereinafter, a more detailed configuration of the rechargeable lithium battery 100 according to one or more embodiments will be described.

A rechargeable lithium battery according to one or more embodiments of the present disclosure may include an electrolyte solution, a positive electrode, and a negative electrode.

The electrolyte solution may include a non-aqueous organic solvent, a lithium salt, and an additive, wherein the non-aqueous organic solvent may contain less than about 5 wt % of ethylene carbonate, based on the total weight of the non-aqueous organic solvent, and the additive may include vinylene carbonate (VC), vinylethylene carbonate (VEC), or a mixture thereof.

The positive electrode may include a positive electrode active material including cobalt-free lithium nickel manganese-based oxide.

In the case of a positive electrode active material including cobalt-free lithium nickel manganese-based oxide, the structural stability of the positive electrode active material is weak under a high-voltage condition, so that solvent decomposition and elution of transition metals, particularly Ni, may occur.

This transition metal elution phenomenon may generate deterioration of performance of a positive electrode and short-circuits for the rechargeable lithium battery, resulting in deteriorating cycle-life characteristics of the battery and sharply increasing resistance of the battery.

However, when the electrolyte solution of one or more embodiments of the present disclosure is utilized, a decrease in cycle-life characteristics and an abrupt increase in resistance of a battery may be alleviated.

In one or more embodiments, the positive electrode including the cobalt-free lithium nickel manganese-based oxide may be used in an electrolyte solution including less than about 5 wt % of ethylene carbonate, based on the total weight of the non-aqueous organic solvent, to effectively reduce elution of transition metals under the high voltage and high temperature conditions and thus, to suppress or reduce collapse of the structure of the positive electrode, thereby improving high-voltage characteristics and high-temperature characteristics of the battery.

The non-aqueous organic solvent serves as a medium for transmitting ions (e.g., lithium ions) taking part in the electrochemical reaction of a battery.

In one or more embodiments, the non-aqueous organic solvent may be a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), and/or the like. The ester-based solvent may include methyl acetate, ethyl acetate, n-propyl acetate, t-butyl acetate, methyl propionate, ethyl propionate, propyl propionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. In some embodiments, the ketone-based solvent may include cyclohexanone, and/or the like. The alcohol-based solvent may include ethanol, isopropyl alcohol, and/or the like, and the aprotic solvent may include nitriles such as R-CN (wherein R is a hydrocarbon group having a C2 to C20 linear, branched, or cyclic structure and may include a double bond, an aromatic ring, or an ether bond), and/or the like, dioxolanes such as 1,3-dioxolane, and/or the like, sulfolanes, and/or the like.

The non-aqueous organic solvent may be utilized alone or in a mixture of two or more. When the non-aqueous organic solvent is utilized in a mixture, the mixing ratio may be controlled or selected in accordance with a desirable battery performance.

For example, in one or more embodiments, the non-aqueous organic solvent may include less than about 5 wt % of ethylene carbonate, based on the total weight of the non-aqueous organic solvent.

When the content (e.g., amount) of ethylene carbonate is greater than or equal to about 5 wt %, because activity of Ni is increased when driven at a high voltage, as the oxidation number of Ni more strongly tends to be reduced from quadrivalent to divalent, the ethylene carbonate with low oxidation stability is oxidatively decomposed, resulting in eluting Ni and precipitating it on the negative electrode.

In one or more embodiments of the present disclosure, the non-aqueous organic solvent may be composed of a chain carbonate alone. In these embodiments, excellent or suitable storage characteristics at a high temperature may be realized as a resistance increase rate is significantly reduced during high-temperature storage.

In the present disclosure, the wording “composed of the chain carbonate” may refer to that it is not mixed with a cyclic carbonate and/or the like as a solvent and includes an organic solvent belonging to the category of a chain carbonate alone or in combination thereof.

In one or more embodiments, the chain carbonate may be represented by Chemical Formula 1.

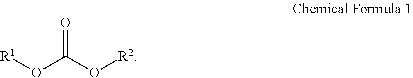

In Chemical Formula 1,

R¹ and R² may each independently be a substituted or unsubstituted C1 to C20 alkyl group.

For example, in some embodiments, R¹ and R² in Chemical Formula 1 may each independently be a substituted or unsubstituted C1 to C10 alkyl group, and for example, in some embodiments, R¹ and R² may each independently be a substituted or unsubstituted C1 to C5 alkyl group.

In one or more embodiments, R¹ and R² in Chemical Formula 1 may each independently be a substituted or unsubstituted methyl group, a substituted or unsubstituted ethyl group, a substituted or unsubstituted n-propyl group, a substituted or unsubstituted n-butyl group, a substituted or unsubstituted n-pentyl group, a substituted or unsubstituted iso-butyl group, or a substituted or unsubstituted neo-pentyl group.

For example, the non-aqueous organic solvent according to one or more embodiments may be a mixture of two or more solvents selected from dimethyl carbonate (DMC), diethyl carbonate (DEC), dipropyl carbonate (DPC), methylpropyl carbonate (MPC), ethylpropyl carbonate (EPC), and ethylmethyl carbonate (EMC).

In one or more embodiments, the non-aqueous organic solvent may be a mixed solvent of dimethyl carbonate (DMC) and ethylmethyl carbonate (EMC).

In one or more embodiments, the non-aqueous organic solvent may include ethylmethyl carbonate (EMC) and dimethyl carbonate (DMC) in a volume ratio of about 0:100 to about 50:50.

In one or more embodiments, it may be more advantageous or suitable in terms of improving battery characteristics that the non-aqueous organic solvent includes dimethyl carbonate (DMC) in an amount of greater than about 50 volume % based on the total volume of the non-aqueous organic solvent.

For example, in some embodiments, the non-aqueous organic solvent may include ethylmethyl carbonate (EMC) and dimethyl carbonate (DMC) in a volume ratio of about 0:100 to about 40:60, or about 0:100 to about 30:70, or about 10:90 to about 40:60, or about 10:90 to about 30:70.

In one or more embodiments, the non-aqueous organic solvent may further include an aromatic hydrocarbon-based organic solvent in addition to the chain carbonate-based solvent. In these embodiments, the chain carbonate-based solvent and the aromatic hydrocarbon-based organic solvent may be mixed in a volume ratio of about 1:1 to about 30:1.

In one or more embodiments, the aromatic hydrocarbon-based organic solvent may be an aromatic hydrocarbon-based compound represented by Chemical Formula 2.

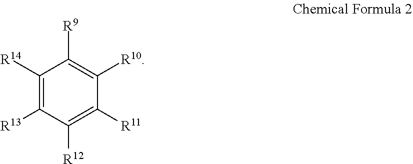

In Chemical Formula 2, R⁹ to R¹⁴ may each independently be the same or different and may each independently be hydrogen, a halogen, a C1 to C10 alkyl group, a C1 to C10 haloalkyl group, or a combination thereof.

Non-limiting examples of the aromatic hydrocarbon-based organic solvent may be benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The lithium salt dissolved in the non-aqueous organic solvent supplies lithium ions in the rechargeable lithium battery, enables a basic operation of the rechargeable lithium battery, and improves transportation of the lithium ions between positive and negative electrodes. Non-limiting examples of the lithium salt may include one or more supporting salts selected from LiPF₆, LiBF₄, lithium difluoro(oxalate)borate (LiDFOB), LiPO₂F₂, LiSbF₆, LiAsF₆, LiN(SO₂C₂F₆)₂, Li(CF₃SO₂)₂N, LiN(SO₃C₂F₆)₂, Li(FSO₂)₂N (lithium bis(fluorosulfonyl)imide, LiFSI), LiC₄F₉SO₃, LiClO₄, LiAlO₂, LiAlCl₄, LiN(CₓF₂ₓ₊₁SO₂)(CyF_{2y+1}SO₂) (wherein, x and y are natural numbers, for example, an integer in a range of 1 to 20), LiCl, LiI, and LiB(C₂O₄)₂ (lithium bis(oxalato) borate, LiBOB).

The lithium salt may be utilized in a concentration in a range of about 0.1 M to about 2.0 M. When the lithium salt is included at the above concentration range, an electrolyte solution may have excellent or suitable performance and lithium ion mobility due to optimal or suitable electrolyte conductivity and viscosity.

In one or more embodiments, the additive may be included in an amount of about 0.05 to about 5.0 parts by weight based on 100 parts by weight of the electrolyte solution for a rechargeable lithium battery.

For example, in some embodiments, the additive may be included in an amount of about 0.05 to about 3.0 parts by weight based on 100 parts by weight of the electrolyte solution for a rechargeable lithium battery.

For example, in some embodiments, the additive may be included in an amount of about 0.1 to about 3.0 parts by weight, about 0.3 to about 3.0 parts by weight, about 0.5 to about 3.0 parts by weight, or about 0.5 to about 2.0 parts by weight based on 100 parts by weight of the electrolyte solution for a rechargeable lithium battery.

When the content (e.g., amount) range of the additive is as described above, a rechargeable lithium battery having improved cycle-life characteristics and output characteristics may be implemented by preventing or reducing an increase in resistance at high temperatures.

In one or more embodiments, the electrolyte solution may further include one or more other additives selected from fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, adiponitrile (AN), succinonitrile (SN), 1,3,6-hexane tricyanide (HTCN), propene sultone (PST), propane sultone (PS), lithium tetrafluoroborate (LiBF₄), lithium difluorophosphate (LiPO₂F₂), and 2-fluoro biphenyl (2-FBP).

By further including the aforementioned other additives, the cycle-life may be further improved or gases generated from the positive electrode and the negative electrode may be effectively controlled or reduced during high-temperature storage.

In one or more embodiments, the other additives may be included in an amount of about 0.2 to about 20 parts by weight, or about 0.2 to about 15 parts by weight, or for example, about 0.2 to about 10 parts by weight, based on 100 parts by weight of the electrolyte solution for a rechargeable lithium battery.

When the amount of the other additives is as described above, the increase in film resistance may be minimized or reduced, thereby contributing to the improvement of battery performance.

In one or more embodiments, the positive electrode may include a positive electrode current collector and a positive electrode active material layer formed on the positive electrode current collector, and the positive electrode active material layer may include a positive electrode active material.

The positive electrode active material may include a cobalt-free lithium nickel manganese-based oxide.

In the present disclosure, the cobalt-free lithium nickel manganese-based oxide as a positive electrode active material may refer to a positive electrode active material composed mainly of nickel, manganese, etc. without including cobalt in the composition of the positive electrode active material.

For example, in one or more embodiments, the cobalt-free lithium nickel manganese-based oxide may include one or more lithium composite oxides represented by Chemical Formula 3.

LiₐNiₓMn_{y}M¹_{z}M²_{w}O_{2±b}X_{c}. Chemical Formula 3

In Chemical Formula 3,
0.5≤a<1.8, 0≤b≤0.1, 0≤c≤0.1, 0≤w<0.1, 0.6≤x<1.0, 0<y<0.4, 0<z<0.1, w+x+y+z=1,

M¹ and M² may each independently be one or more elements selected from Al, Mg, Ti, Zr, Cr, Sr, V, B, W, Mo, Nb, Si, Ba, Ca, Ce, and Fe, and X may be one or more elements selected from S, F, P, and Cl.

The lithium composite oxide may have a coating layer on the surface of the lithium composite oxide, or the lithium composite oxide may be mixed with another compound/composition having a coating layer. The coating layer may include one or more coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include magnesium (Mg), aluminum (Al), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a mixture thereof. The coating process may include any suitable processes as long as it does not cause any side effects on the properties of the positive electrode active material (e.g., inkjet coating, dipping), which is well established to persons having ordinary skill in this art, so a detailed description thereof is not provided for conciseness.

For example, in one or more embodiments, the lithium composite oxides represented by Chemical Formula 3 may be represented by Chemical Formula 3-1.

LiₐNiₓ₁Mn_{y1}Al_{z1}M²_{w1}O_{2±b}X_{c}, and Chemical Formula 3-1

In Chemical Formula 3-1,
0.5≤a<1.8, 0≤b≤0.1, 0≤c≤0.1, 0≤w1<0.1, 0.6≤x1<1.0, 0<y1<0.4, 0<z1<0.1, w1+x1+y1+z1=1,

M² may each independently be one or more elements selected from Mg, Ti, Zr, Cr, Sr, V, B, W, Mo, Nb, Si, Ba, Ca, Ce, and Fe, and X may be one or more element selected from S, F, P, and Cl.

In one or more embodiments, in Chemical Formula 3-1, 0.6≤x1≤0.9, 0.1≤y1<0.4, and 0<z1<0.1, or 0.6≤x1≤0.8, 0.2≤y1<0.4, and 0<z1<0.1.

For example, in some embodiments, in Chemical Formula 3-1, x1 may be 0.6≤x1≤0.79, y1 may be 0.2≤y1≤0.39, and z1 may be 0.01≤z1<0.1.

The content (e.g., amount) of the positive electrode active material may be about 90 wt % to about 98 wt % based on the total weight of the positive electrode active material layer.

In one or more embodiments, the positive electrode active material layer may include a binder. The content (e.g., amount) of the binder may be about 1 wt % to about 5 wt % based on the total weight of the positive electrode active material layer.

The binder improves binding properties of positive electrode active material particles with one another and with the positive electrode current collector. Non-limiting examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but embodiments of the present disclosure are not limited thereto.

The positive electrode current collector may include Al foil, but embodiments of the present disclosure are not limited thereto.

The negative electrode may include a negative electrode current collector and a negative electrode active material layer including a negative electrode active material formed on the negative electrode current collector.

The negative electrode active material may include a material that reversibly intercalates/deintercalates lithium ions, a lithium metal, a lithium metal alloy, a material capable of doping/dedoping lithium, and/or a transition metal oxide.

The material that reversibly intercalates/deintercalates lithium ions may include carbon materials. The carbon material may be any generally-utilized carbon-based negative electrode active material in a rechargeable lithium battery. Non-limiting examples of the carbon material may include crystalline carbon, amorphous carbon, and/or a combination thereof. The crystalline carbon may be non-shaped (e.g., irregularly shaped), or sheet, flake, substantially spherical, or fiber shaped natural graphite or artificial graphite, and the amorphous carbon may be a soft carbon, a hard carbon, a mesophase pitch carbonization product, calcined coke, and/or the like.

The lithium metal alloy may include lithium and a metal selected from sodium (Na), potassium (K), rubidium (Rb), cesium (Cs), francium (Fr), beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (Al), and tin (Sn).

The material capable of doping/dedoping lithium may be Si, a Si—C composite, SiOₓ (0<x<2), a Si-Q alloy (wherein Q is an element selected from an alkali metal, an alkaline-earth metal, a Group 13 element, a Group 14 element except Si, a Group 15 element, a Group 16 element, a transition metal, a rare earth element, and a combination thereof), Sn, SnO₂, a Sn—R¹¹ alloy (wherein R¹¹ is an element selected from an alkali metal, an alkaline-earth metal, a Group 13 element, a Group 14 element except Sn, a Group 15 element, a Group 16 element, a transition metal, a rare earth element, and a combination thereof), and/or the like. At least one of these materials may be mixed with SiO₂.

The elements Q and R¹¹ may each independently be selected from magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), thallium (TI), germanium (Ge), phosphorus (P), arsenic (As), antimony (Sb), bismuth (Bi), sulfur (S), selenium (Se), tellurium (Te), polonium (Po), and a combination thereof.

The transition metal oxide may be a vanadium oxide, a lithium vanadium oxide, and/or the like.

In one or more embodiments, the negative electrode active material may include graphite, a Si composite, or a mixture thereof.

The Si composite may include a core including Si-based particles and an amorphous carbon coating layer. For example, in one or more embodiments, the Si-based particles may include one or more selected from silicon particles, a Si—C composite, SiOₓ (0<x≤2), and a Si alloy.

For example, voids may be included in the central portion of the core including the Si-based particles, a radius of the central portion may correspond to about 30% to about 50% of the radius of the Si composite, an average particle diameter of the Si composite may be about 5 μm to about 20 μm, and an average particle diameter of the Si-based particles may be about 10 nm to about 200 nm.

In the present disclosure, an average particle diameter (D50) may be a particle size at a volume ratio of 50% in a cumulative size-distribution curve.

When the average particle diameter of the Si-based particles is within the above ranges, volume expansion occurring during charging and discharging may be suppressed or reduced, and interruption of a conductive path due to particle crushing during charging and discharging may be prevented or reduced.

In one or more embodiments, the core including the Si-based particles may further include amorphous carbon, and the central portion may not include(e.g., may exclude) amorphous carbon, and the amorphous carbon may exist (e.g., may be present) only in the surface portion of the Si composite.

Herein, the surface portion of the Si composite may refer to a region from the outermost surface of the central portion to the outermost surface of the Si composite.

In one or more embodiments, the Si-based particles are substantially uniformly included throughout Si composite, that is, may be present in a substantially uniform concentration in the central portion and surface portion.

The amorphous carbon may be soft carbon, hard carbon, a mesophase pitch carbonized product, calcined coke, or a combination thereof.

For example, in some embodiments, the Si-C composite may include silicon particles and crystalline carbon.

The silicon particles may be included in an amount of about 1 wt % to about 60 wt %, for example, about 3 wt % to about 60 wt %, based on the total weight of the Si-C composite.

The crystalline carbon may be, for example, graphite, for example, natural graphite, artificial graphite, or a combination thereof.

An average particle diameter of the crystalline carbon may be about 5 μm to about 30 μm.

In one or more embodiments, when the negative electrode active material

includes the graphite and Si composite together, the graphite and Si composite may be included in the form of a mixture, and the graphite and Si composite may be included in a weight ratio of about 99:1 to about 50:50.

In some embodiments, the graphite and Si composite may be included in a weight ratio of about 97:3 to about 80:20, or about 95:5 to about 80:20.

The amorphous carbon precursor may be coal-based pitch, mesophase pitch, petroleum-based pitch, coal-based oil, petroleum-based heavy oil, and/or a polymer resin such as a phenol resin, a furan resin, or a polyimide resin.

In the negative electrode active material layer, the negative electrode active material may be included in an amount of about 95 wt % to about 99 wt % based on the total weight of the negative electrode active material layer.

In one or more embodiments, the negative electrode active material layer may further include a binder, and optionally a conductive material. The content (e.g., amount) of the binder in the negative electrode active material layer may be about 1 wt % to about 5 wt % based on the total weight of the negative electrode active material layer. In the negative electrode active material layer, the amount of the conductive material may be about 1 wt % to about 5 wt % based on the total weight of the negative electrode active material layer.

The binder improves binding properties of negative electrode active material particles with one another and with the negative electrode current collector. The binder may be a non-water-soluble binder, a water-soluble binder, or a combination thereof.

The non-water-soluble binder may be polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a rubber-based binder and/or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, ethylenepropylene co-polymer, polyethylene oxide, polyvinylpyrrolidone, polyepichlorohydrin, polyphosphazene, polyacrylonitrile, polystyrene, an ethylene propylene diene copolymer, polyvinylpyridine, chlorosulfonated polyethylene, latex, a polyester resin, an acrylic resin, a phenolic resin, an epoxy resin, polyvinyl alcohol, or a combination thereof.

In one or more embodiments, when the water-soluble binder is utilized as a negative electrode binder in the negative electrode active material layer, a cellulose-based compound may be further utilized to provide viscosity as a thickener. The cellulose-based compound may include one or more of carboxymethyl cellulose, hydroxypropylmethyl cellulose, methyl cellulose, or alkali metal salts thereof. The alkali metals may be Na, K, or Li. Such a thickener may be included in an amount of about 0.1 to about 3 parts by weight based on 100 parts by weight of the negative electrode active material.

In one or more embodiments, the conductive material may be included to provide electrode conductivity, and any electrically conductive material may be utilized as a conductive material unless it causes a chemical change. Non-limiting examples of the conductive material may include a carbon-based material such as natural graphite, artificial graphite, carbon black, acetylene black, ketjen black, a carbon fiber, and/or the like; a metal-based material including a metal powder or a metal fiber of copper, nickel, aluminum silver, and/or the like; a conductive polymer such as a polyphenylene derivative; or a mixture thereof.

The negative electrode current collector may be selected from a copper foil, a nickel foil, a stainless steel foil, a titanium foil, a nickel foam, a copper foam, a polymer substrate coated with a conductive metal, and a combination thereof.

In one or more embodiments, the rechargeable lithium battery may further include a separator between the negative electrode and the positive electrode, depending on a type or kind of the battery. Such a separator may for example include polyethylene, polypropylene, polyvinylidene fluoride, and multi-layers thereof such as a polyethylene/polypropylene double-layered separator, a polyethylene/polypropylene/polyethylene triple-layered separator, and/or a polypropylene/polyethylene/polypropylene triple-layered separator.

The rechargeable lithium battery may have a charging upper limit voltage of greater than or equal to about 4.35 V. For example, the charging upper limit voltage may be about 4.35 V to about 4.55 V.

Hereinafter, examples of the present disclosure and comparative examples are described. These examples, however, are not in any sense to be interpreted as limiting the scope of the present disclosure.

### Manufacture of Rechargeable Lithium Battery Cells

### Example 1

LiNi_{0.75}Mn_{0.23}Al_{0.02}O₂ as a positive electrode active material, polyvinylidene fluoride as a binder, and acetylene black as a conductive material were mixed in a weight ratio of 96:3:1 and then, dispersed in N-methyl pyrrolidone, preparing positive electrode active material slurry.

The positive electrode active material slurry was coated on a 15 μm-thick Al foil, dried at 100° C., and pressed, manufacturing a positive electrode.

Negative electrode active material slurry was prepared by utilizing a mixture of artificial graphite and Si composite in a weight ratio of 93:7 as a negative electrode active material and then, mixing the negative electrode active material, a styrene-butadiene rubber binder, and carboxylmethyl cellulose in a weight ratio of 98:1:1 and dispersing the obtained mixture in distilled water.

As for the Si composite, a core including artificial graphite and silicon particles was coated with coal-based pitch on the surface.

The negative electrode active material slurry was coated on a 10 μm-thick Cu foil, dried at 100° C., and pressed, manufacturing a negative electrode.

The manufactured positive and negative electrodes were assembled with a 10 μm-thick polyethylene separator to manufacture an electrode assembly, and an electrolyte solution was injected thereinto, manufacturing a rechargeable lithium battery cell.

The electrolyte solution had a composition as follows.

(Composition of Electrolyte Solution)

Lithium salt: 1.5 M LiPF₆

Non-aqueous organic solvent:ethylmethyl carbonate:dimethyl carbonate (EMC:DMC=a volume ratio of 20:80)

Additive: 1 part by weight of vinylene carbonate (VC)

(In the composition of the electrolyte solution, the phrase “parts by weight” refers to the relative weight of the additive based on 100 parts by weight of the total electrolyte solution (lithium salt+non-aqueous organic solvent) except the additive.)

### Comparative Example 1

A rechargeable lithium battery cell was manufactured in substantially the same manner as in Example 1, except that vinylene carbonate was not added in the composition of the electrolyte solution.

### Comparative Example 2

A rechargeable lithium battery cell was manufactured in substantially the same manner as in Example 1, except that 20 wt % of ethylene carbonate was added based on the total weight of the non-aqueous organic solvent in the composition of the electrolyte solution.

### Example 2

A rechargeable lithium battery cell was manufactured in substantially the same manner as in Example 1, except that 1 part by weight of vinylethylene carbonate was added instead of vinylene carbonate in the composition of the electrolyte solution.

### Comparative Example 3

A rechargeable lithium battery cell was manufactured in substantially the same manner as in Example 1, except that 1 part by weight of fluoroethylene carbonate (FEC) was added instead of vinylene carbonate in the composition of the electrolyte solution.

### Examples 3 and 4

Rechargeable lithium battery cells were manufactured in substantially the same manner as in Examples 1 and 2, except that the non-aqueous organic solvent was changed to dimethyl carbonate, i.e., only dimethyl carbonate was utilized as the non-aqueous organic solvent.

### Comparative Examples 4 to 7

Rechargeable lithium battery cells were manufactured in substantially the same manner as in Examples 1 and 2 and Comparative Examples 1 and 2, respectively, except that the positive electrode active material was changed to LiCoO₂.

### Comparative Examples 8 to 11

Rechargeable lithium battery cells were manufactured in substantially the same manner as in Examples 1 and 2 and Comparative Examples 1 and 2, respectively, except that the positive electrode active material was changed to LiNi_{0.5}Co_{0.2}Al_{0.3}O₂.

### Comparative Examples 12 to 15

Rechargeable lithium battery cells were manufactured in substantially the same manner as in Examples 1 and 2 and Comparative Examples 1 and 2, respectively, except that the positive electrode active material was changed to LiNi_{0.8}Co_{0.1}Mn_{0.1}O₂.

### Examples 5 to 7

Rechargeable lithium battery cells were manufactured in substantially the same manner as in Example 1, except that the mixing ratio of ethylmethyl carbonate and dimethyl carbonate was changed to a volume ratio of 30:70 (Example 5), a volume ratio of 40:60 (Example 6), and a volume ratio of 70:30 (Example 7).

### Evaluation 1: Evaluation of High-Temperature Storage Characteristics

The rechargeable lithium battery cells according to Examples 1 to 7 and Comparative Examples 1 to 15 were each measured with respect to initial DC resistance (DC-IR) as ΔV/ΔI (change in voltage/change in current), and after changing a maximum energy state inside the rechargeable lithium battery cells into a full charge state (i.e., state of charge (SOC) 100%) and storing the cells in this state at a high temperature (60° C.) for 30 days, the cells were each measured with respect to DC internal resistance to calculate a DC-IR increase rate (%) according to Equation 1, and the results are shown in Table 1, Table 2, and Table 5.

DC-IR increase rate={(DC-IR after 30 days−initial DC-IR)/initial DC-IR}×100% Equation 1

### Evaluation 2: Evaluation of High-Temperature Cycle-Life Characteristics

The rechargeable lithium battery cells of Examples 1 to 4 and Comparative Examples 1 to 3 each were once charged and discharged at 0.2 C and then, measured with respect to charge and discharge capacity.

In addition, the rechargeable lithium battery cells according to Examples 1 to 4 and Comparative Examples 1 to 3 were each charged to a charge upper limit voltage of 4.4 V and discharged to 2.5 V at 0.2 C under a constant current condition and then, measured with respect to initial discharge capacity.

While 200 cycles charged and discharged under conditions of 0.33 C charge (constant current (CC)/constant voltage (CV), 4.4 V, 0.025 C cut-off)/1.0 C discharge (CC, 2.5 V cut-off) at 45° C., the cells were each measured with respect to discharge capacity. A ratio of the discharge capacity to the initial discharge capacity was shown as a capacity recovery rate (%, recovery) in Table 4.

Increase rate compared to Comparative Example 2=[{(Capacity recovery rate)−(Capacity recovery rate of Comparative Example 2)}(Capacity recovery rate of Comparative Example 2)]*100(%) Equation 2

Evaluation 3: Measurement of Gas Generation after High-Temperature Storage

The rechargeable lithium battery cells according to Examples 1 to 4 and Comparative Examples 1 to 3 were each allowed to stand at 60° C. for 7 days and then, measured with respect to each gas generation amount (mL) on the 1^{st} and 7^{th} days by utilizing Refinery Gas Analysis (RGA), and the results are shown in Table 3.

TABLE 1

| | | DC-IR after | |
|---|---|---|---|
| | | storage at | |
| | | high | |
| | | temperature | DC-IR |
| | | (60° C.) | Increase rate |
| | Initial DC-IR | for 30 days | (60° C., 30 days) |
| | (mΩ) | (mΩ) | (%) |
| Example 1 | 42.14 | 44.67 | 106 |
| Example 2 | 42.12 | 45.07 | 107 |
| Example 3 | 42.11 | 43.79 | 104 |
| Example 4 | 42.09 | 43.35 | 103 |
| Comparative | 42.18 | 45.98 | 109 |
| Example 1 | | | |
| Comparative | 42.31 | 52.04 | 123 |
| Example 2 | | | |
| Comparative | 42.28 | 50.21 | 119 |
| Example 3 | | | |

TABLE 2

| | | | DC-IR after | |
|---|---|---|---|---|
| | | | storage | DC-IR |
| | | | at high | Increase |
| | | | temperature | rate |
| | | Initial | (60° C.) | (60° C., |
| Positive electrode | | DC-IR | for 30 days | 30 days) |
| active material | | (mΩ) | (mΩ) | (%) |
| LiNi_{0.75}Mn_{0.23}Al_{0.02}O₂ | Example 1 | 42.14 | 44.67 | 106 |
| | Example 2 | 42.12 | 45.07 | 107 |
| | Comparative | 42.18 | 45.98 | 109 |
| | Example 1 | | | |
| | Comparative | 42.31 | 52.04 | 123 |
| | Example 2 | | | |
| LiCoO₂ | Comparative | 42.30 | 52.03 | 123 |
| | Example 4 | | | |
| | Comparative | 42.29 | 52.44 | 124 |
| | Example 5 | | | |
| | Comparative | 42.34 | 52.08 | 123 |
| | Example 6 | | | |
| | Comparative | 42.43 | 52.61 | 124 |
| | Example 7 | | | |
| LiNi_{0.5}Co_{0.2}Al_{0.3}O₂ | Comparative | 42.26 | 51.13 | 121 |
| | Example 8 | | | |
| | Comparative | 42.25 | 51.55 | 122 |
| | Example 9 | | | |
| | Comparative | 42.27 | 50.72 | 120 |
| | Example 10 | | | |
| | Comparative | 42.33 | 46.99 | 111 |
| | Example 11 | | | |
| LiNi_{0.8}Co_{0.1}Mn_{0.1}O₂ | Comparative | 42.29 | 50.99 | 121 |
| | Example 12 | | | |
| | Comparative | 42.28 | 51.27 | 121 |
| | Example 13 | | | |
| | Comparative | 42.30 | 51.68 | 122 |
| | Example 14 | | | |
| | Comparative | 42.37 | 52.14 | 123 |
| | Example 15 | | | |

TABLE 3

| | Amount of gas generated after storage | | |
|---|---|---|---|
| | at high temperature (60° C.) | | |
| | 1 day | 7 days | Increase rate |
| | (mL) | (mL) | (%) |
| Example 1 | 1.06 | 1.45 | 137 |
| Example 2 | 1.04 | 1.44 | 138 |
| Example 3 | 1.03 | 1.39 | 135 |
| Example 4 | 1.02 | 1.39 | 136 |
| Comparative Example | 1.12 | 1.68 | 150 |
| 1 | | | |
| Comparative Example | 1.33 | 3.64 | 274 |
| 2 | | | |
| Comparative Example | 1.25 | 3.21 | 257 |
| 3 | | | |

TABLE 4

| | Capacity recovery | Increase rate compared |
|---|---|---|
| | rate | to Comparative |
| | (45° C., 200 cycle, | Example 2 |
| | %) | (%) |
| Example 1 | 95.1 | 26 |
| Example 2 | 95.2 | 26 |
| Example 3 | 96.1 | 27 |
| Example 4 | 96.2 | 28 |
| Comparative | 94.1 | — |
| Example 1 | | |
| Comparative | 75.4 | — |
| Example 2 | | |
| Comparative | 83.6 | 11 |
| Example 3 | | |

TABLE 5

| | | DC-IR after storage | DC-IR |
|---|---|---|---|
| | | at high temperature | Increase rate |
| | Initial | (60° C.) | (60° C., 30 |
| | DC-IR | for 30 days | days) |
| | (mΩ) | (mΩ) | (%) |
| Example 1 | 42.14 | 44.67 | 106 |
| Example 3 | 42.11 | 43.79 | 104 |
| (EMC:DMC = 0:100) | | | |
| Example 5 | 42.17 | 44.99 | 107 |
| (EMC:DMC = 30:70) | | | |
| Example 6 | 42.21 | 45.43 | 108 |
| (EMC:DMC = 40:60) | | | |
| Example 7 | 42.32 | 49.10 | 116 |
| (EMC:DMC = 70:30) | | | |
| Comparative Example | 42.31 | 52.04 | 123 |
| 2 | | | |
| EC 20 wt % | | | |

Referring to Tables 1, 2 and 5, the compositions of the present disclosure in which the electrolyte solution of the present disclosure and Co-free positive electrode active material were combined, exhibited a decrease in the DC-IR increase rate and thus all improved high-temperature storage characteristics. When the additive according to the present disclosure is not included (Comparative Example 1), when other additives are included (Comparative Example 3), when EC is included in an amount of greater than or equal to 5 wt % (Comparative Example 2), and when other positive electrode active materials are included, i.e., in the case of including the composition of the electrolyte solution of (Comparative Examples 4 to 15), it can be expected that the DC-IR increase rate increases after high-temperature storage, resulting in a decrease in battery cycle-life characteristics.

It was confirmed that the composition of the non-aqueous organic solvent showed a more excellent or suitable effect when the volume ratio of EMC:DMC was 0:100 to 50:50.

Referring to Table 3, when the electrolyte solutions according to one or more embodiments of the present disclosure were utilized, the gas generation amounts after the high-temperature storage were significantly reduced.

Referring to Table 4, it can be seen that the high-temperature charge/discharge characteristics are improved by reducing the DC-IR increase rate in the composition in which the electrolyte solution and the Co-free positive electrode active material according to the present disclosure are combined.

Herein, it should be understood that terms such as “comprise(s),” “include(s),” or “have/has” are intended to designate the presence of an embodied feature, number, step, element, or a combination thereof, but it does not preclude the possibility of the presence or addition of one or more other features, numbers, steps, elements, or a combination thereof.

In present disclosure, the average particle diameter (or size) may be measured by a method well suitable to those skilled in the art, for example, may be measured by a particle size analyzer, for example, HORIBA, LA-950 laser particle size analyzer, or may be measured by a transmission electron microscope (TEM) or a scanning electron microscope(SEM). In some embodiments, it is possible to obtain an average particle diameter value by measuring it utilizing a dynamic light scattering method, performing data analysis, counting the number of particles for each particle size range, and calculating from the data. In some embodiments, the average particle diameter (or size) may be measured by a microscope or a particle size analyzer and may refer to a diameter (D50) of particles having a cumulative volume of 50 volume % in a particle size distribution. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size. Also, in the present disclosure, when particles are spherical, “diameter” indicates a particle diameter or an average particle diameter, and when the particles are non-spherical, the “diameter” indicates a major axis length or an average major axis length.

Herein, “or” is not to be construed as an exclusive meaning, for example, “A or B” is construed to include A, B, A+B, and/or the like. Further, as used herein, the term “and/or” includes any and all combinations of one or more of the associated listed items. The “/” utilized herein may be interpreted as “and” or as “or” depending on the situation. Expressions such as “at least one of,” “one of,” and “selected from,” when preceding a list of elements, modify the entire list of elements and do not modify the individual elements of the list. For example, “at least one of a, b, or c”, “at least one of a, b, and/or c”, “at least one selected from a, b, and c”, “at least one selected from among a to c”, etc. may indicate only a, only b, only c, both (e.g., simultaneously) a and b, both (e.g., simultaneously) a and c, both (e.g., simultaneously) b and c, all of a, b, and c, or variations thereof.

As utilized herein, the singular forms “a,” “an,” and “the” are intended to include the plural forms as well, unless the context clearly indicates otherwise. Further, the use of “may” when describing embodiments of the present disclosure may refer to “one or more embodiments of the present disclosure”.

As utilized herein, the terms “substantially,” “about,” and similar terms are used as terms of approximation and not as terms of degree, and are intended to account for the inherent deviations in measured or calculated values that would be recognized by those of ordinary skill in the art.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While the present disclosure has been described in connection with what is presently considered to be practical example embodiments, it is to be understood that the present disclosure is not limited to the disclosed embodiments, but, on the contrary, is intended to cover one or more suitable modifications and equivalent arrangements included within the spirit and scope of the appended claims and equivalents thereof.

### REFERENCE NUMERALS

100: rechargeable lithium battery
112: negative electrode
113: separator
114: positive electrode
120: battery case
140: sealing member

What is claimed is:

1. A rechargeable lithium battery, comprising
an electrolyte solution comprising a non-aqueous organic solvent, an additive, and a lithium salt;
a positive electrode comprising a positive electrode active material; and
a negative electrode comprising a negative electrode active material,
wherein the non-aqueous organic solvent contains less than about 5 wt % of ethylene carbonate, based on the total weight of the non-aqueous organic solvent,
the additive comprises vinylene carbonate (VC), vinylethylene carbonate (VEC), or a mixture thereof, and
the positive electrode active material comprises a cobalt-free lithium nickel manganese-based oxide.

2. The rechargeable lithium battery of claim 1, wherein
the non-aqueous organic solvent is composed of a chain carbonate alone.

3. The rechargeable lithium battery of claim 2, wherein
the chain carbonate is represented by Chemical Formula 1: 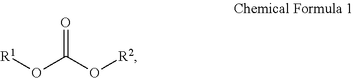
and
wherein, in Chemical Formula 1,
R¹ and R² are each independently a substituted or unsubstituted C1 to C20 alkyl group.

4. The rechargeable lithium battery of claim 1, wherein
the non-aqueous organic solvent is a mixture of two or more solvents selected from dimethyl carbonate (DMC), diethyl carbonate (DEC), dipropyl carbonate (DPC), methylpropyl carbonate (MPC), ethylpropyl carbonate (EPC), and ethylmethyl carbonate (EMC).

5. The rechargeable lithium battery of claim 1, wherein
the non-aqueous organic solvent comprises ethylmethyl carbonate (EMC) and dimethyl carbonate (DMC) in a volume ratio of about 0:100 to about 50:50.

6. The rechargeable lithium battery of claim 1, wherein
the additive is included in an amount of about 0.05 to about 5.0 parts by weight based on 100 parts by weight of the electrolyte solution.

7. The rechargeable lithium battery of claim 1, wherein
The additive is included in an amount of about 0.05 to about 3.0 parts by weight based on 100 parts by weight of the electrolyte solution.

8. The rechargeable lithium battery of claim 1, wherein
the electrolyte solution further comprises one or more other additives selected from fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, adiponitrile (AN), succinonitrile (SN), 1,3,6-hexane tricyanide (HTCN), propene sultone (PST), propane sultone (PS), lithium tetrafluoroborate (LiBF₄), lithium difluorophosphate (LiPO₂F₂), and 2-fluoro biphenyl (2-FBP).

9. The rechargeable lithium battery of claim 1, wherein
the cobalt-free lithium nickel manganese-based oxide comprises a lithium composite oxide represented by Chemical Formula 3:
LiₐNiₓMn_{y}M¹_{z}M²_{w}O_{2±b}X_{c}, and Chemical Formula 3
wherein, in Chemical Formula 3,
0.5≤a<1.8, 0≤b≤0.1, 0≤c≤0.1, 0≤w<0.1, 0.6≤x<1.0, 0<y<0.4, 0<z<0.1, w+x+y+z=1,
M¹ and M² are each independently one or more elements selected from Al, Mg, Ti, Zr, Cr, Sr, V, B, W, Mo, Nb, Si, Ba, Ca, Ce, and Fe, and
X is one or more elements selected from S, F, P, and Cl.

10. The rechargeable lithium battery of claim 9, wherein
the lithium composite oxide represented by Chemical Formula 3 is represented by Chemical Formula 3-1:
LiₐNiₓ₁Mn_{y1}Al_{z1}M²_{w1}O_{2±b}X_{c}, and Chemical Formula 3-1
wherein, in Chemical Formula 3-1,
0.5≤a<1.8, 0≤b≤0.1, 0≤c≤0.1, 0≤w1<0.1, 0.6≤x1<1.0, 0<y1<0.4, 0<z1<0.1, w1+x1+y1+z1=1,
M² is each independently one or more elements selected from Mg, Ti, Zr, Cr, Sr, V, B, W, Mo, Nb, Si, Ba, Ca, Ce, and Fe, and
X is one or more elements selected from S, F, P, and Cl.

11. The rechargeable lithium battery of claim 10, wherein
in Chemical Formula 3-1, 0.6≤x1≤0.79, 0.2≤y1≤0.39, and z1 is 0.01≤z1<0.1.

12. The rechargeable lithium battery of claim 1, wherein
the negative electrode active material comprises graphite, a Si composite, or a mixture thereof.

13. The rechargeable lithium battery of claim 1, wherein
the rechargeable lithium battery has a charging upper limit voltage of greater than or equal to about 4.35 V.
